(19) United States
(12) Patent Application Publication
(10) Pub. No.: US 2014/0272846 A1
(43) Pub. Date: Sep. 18, 2014

(54) SYSTEMS AND METHODS FOR ALTERING AN INDIVIDUAL'S BEHAVIOR

(71) Applicant: Health Fitness Corporation, Minneapolis, MN (US)

(72) Inventor: Dennis E. Richling, Evanston, IL (US)

(21) Appl. No.: 14/208,541

(22) Filed: Mar. 13, 2014

Related U.S. Application Data
(60) Provisional application No. 61/801,958, filed on Mar. 15, 2013.

(51) Int. Cl. G09B 19/00

(52) U.S. Cl. CPC G09B 19/00
USPC 434/236

(57) ABSTRACT

Systems and methods for altering participants' behaviors associated with a health care system are provided. In one example, a method of altering a behavior of a participant associated with a health care system includes assessing activities of the participant over a network via at least one electronic device, determining a behavior of the participant based on the activities of the participant, determining a motivation level of the participant, the motivation level is associated with an extent to which the participant is willing to change the behavior, categorizing the participant into a first category of a plurality of categories based on the behavior and the motivation level of the participant, and communicating with the participant based on the category in which the participant is categorized over a network via at least one electronic device.

### RELATED APPLICATIONS

The present application claims the benefit of co-pending U.S. Provisional Patent Application No. 61/801,958, filed Mar. 15, 2013, the entire contents of which is incorporated by reference herein.

### FIELD OF THE INVENTION

The present disclosure relates generally to systems and methods related to individuals' behaviors and, more particularly, to systems and methods for altering individuals' behaviors.

### BACKGROUND

It has long been recognized that there is a need to ameliorate physical, psychological, and emotional problems that derive from ill effects of unhealthy behaviors, and much has been published on the theoretical models of behaviors and the inherent resistance to change them.

Conventional efforts to cause change in behaviors have centered on urging an individual to increase his or her motivation to change the undesirable behavior patterns. The underlying premise is a belief that motivation can be elevated to a level that overcomes the addiction patterns associated with unhealthy behaviors. This approach often takes the form of increasing the individual's awareness of a behavior, since oftentimes the individual will engage in the unhealthy behavior without being fully aware of the acts associated with the unhealthy behaviors and the consequences. Of course, achievement of an adequate level of awareness is especially problematical when the unhealthy behaviors are acts of omission. It is well known that the conventional approaches to behavior modification have had unacceptably limited success.

There is therefore a need for systems and/or methods that successfully urge individuals to alter unhealthy behavior patterns.

There is additionally a need for systems and/or methods that can achieve desired modification of unhealthy behavior at reasonable cost. That is, without the need for expensive medications or sequestration of the individual while intensive therapies are administered.

### SUMMARY

In one aspect, the foregoing and other objects are achieved by providing systems and methods that identify, address, and alter unhealthy behaviors while requiring little or no increase in motivation. More specifically, an individual that employs the systems and/or methods of the present disclosure will develop new and healthy behaviors by habit development that supports and results in new and more complex behaviors. The system receives and collects inputted data and analyzes the collected data to define behavior segments or categories. The data may be collected over one or more networks such as, for example, the Internet, cellular network, or may be collected in non-electronic manners such as mailings, paper surveys, or any other manner. The identified behavior segments or categories are associated with subsequent interactions with individuals in a variety of manners.

Two exemplary types of behaviors that may create risk for individuals developing chronic disease or other harmful health conditions include: Unhealthy behaviors; and absent behaviors. Unhealthy behaviors are those that the individual has and are unhealthy. Absent behaviors are those that are not present and, by virtue of not being present, create risk of developing chronic disease or other harmful health conditions.

In accordance with the above example, the two exemplary types of behaviors have unique interventional approaches to create change. In one example, the systems and methods of the present disclosure recognize a need for different intervention approaches for different classifications of behaviors, and the systems and methods of the disclosure assess and determine a most effective behavior change intervention to deliver to the individual based on the individual's personal needs.

In one aspect, the systems and methods of the disclosure analyze the individual's motivation and the health risks associated with the unhealthy behaviors (e.g., problem behaviors and absent behaviors). The individual then is assigned to a behavior segment or category that represents a unique approach to effect change by incorporating one or more behavior change components based on the individual's situation. Exemplary behavior change components include, but are not limited to: A transtheoretical model; a radical behaviorism/behavior analysis; behavioral economics; consumer psychology; etc.

In one aspect, the systems and methods of the present disclosure employ a health assessment of an individual that assesses a plurality of types of health risks. Exemplary types of assessed health risks include, but are not limited to: Unhealthy behaviors; healthy behaviors; and biometric risks. Unhealthy behaviors are behaviors that are already present and that contribute to the risk of developing chronic disease or other harmful health condition (e.g., smoking, eating unhealthy fats, etc.). Absence of healthy behaviors also contributes to developing chronic disease or other harmful health condition (e.g., lack of aerobic exercise, etc.), which may be referred to as absent behaviors. Biometric risks are either reported or professionally collected and may be included in the systems and methods of the present disclosure.

In one example, a method of altering a behavior of a participant associated with a health care system is provided. The method includes assessing activities of the participant over a network via at least one electronic device, determining a behavior of the participant based on the activities of the participant, determining a motivation level of the participant, wherein the motivation level is associated with an extent to which the participant is willing to change the behavior, categorizing the participant into a first category of a plurality of categories based on the behavior and the motivation level of the participant, and communicating with the participant based on the category in which the participant is categorized over a network via at least one electronic device.

In one example, the step of assessing activities further includes presenting a plurality of questions to the participant over the network to the at least one electronic device, displaying the plurality of questions on the at least one electronic device for viewing by the participant, and communicating data associated with the participant's answers to the plurality of questions over the network.

In one example, the network is one of an Internet, an intranet, a cellular network, a local area network (LAN), a wide area network (WAN), and a cable network.

In one example, the at least one electronic device is at least one of a personal computer, a portable computer, a tablet computer, a smartphone, a cellular phone, and a hardwired telephone.

In one example, the behavior is one of an unhealthy behavior and an absent behavior.

In one example, the step of categorizing further includes categorizing the participant in the first category when the behavior is an unhealthy behavior and categorizing the participant in a second category different than the first category when the behavior is an absent behavior.

In one example, the step of communicating further includes intervening with the participant at a first intervention level when the participant is categorized in the first category, and intervening with the participant at a second intervention level when the participant is categorized in the second category, wherein the first intervention level and the second intervention level are different.

In one example, the behavior is one of an unhealthy behavior and an absent behavior, and the motivation level is one of a high motivation level and a low motivation level.

In one example, the step of categorizing further includes categorizing the participant in the first category when the behavior is an unhealthy behavior and the motivation level is a high motivation level, categorizing the participant in a second category of the plurality of categories when the behavior is an unhealthy behavior and the motivation level is a low motivation level, categorizing the participant in a third category of the plurality of categories when the behavior is an absent behavior and the motivation level is a high motivation level, and categorizing the participant in a fourth category of the plurality of categories when the behavior is an absent behavior and the motivation level is a low motivation level.

In one example, the step of communicating further includes intervening with the participant at a first intervention level when the participant is categorized in the first category, intervening with the participant at a second intervention level when the participant is categorized in the second category, intervening with the participant at a third intervention level when the participant is categorized in the third category, and intervening with the participant at a fourth intervention level when the participant is categorized in the fourth category, wherein the first intervention level, the second intervention level, the third intervention level and the fourth intervention level are different. In one example, when the behavior is an absent behavior, the method further includes comparing the absent behavior to a list of healthy behaviors stored in a database, and identifying at least one healthy behavior absent from the activities of the participant.

In one example, the step of determining a motivation level of the participant further includes displaying the at least one healthy behavior on the electronic device for the participant to view, and presenting at least one motivation question to the participant on the electronic device pertaining to the at least one healthy behavior displayed on the electronic device to determine the motivation level of the participant to begin performing the at least one healthy behavior.

In one example, the motivation level is a high motivation level when the participant has a high level of motivation to begin performing the at least one healthy behavior, and the motivation level is a low motivation level when the participant has a low level of motivation to begin performing the at least one healthy behavior. The step of categorizing further includes categorizing the participant in the first category when the participant has a high motivation level and categorizing the participant in a second category of the plurality of categories different than the first category when the participant has a low motivation level.

In one example, the step of communicating further includes intervening with the participant at a first intervention level when the participant is categorized in the first category, and intervening with the participant at a second intervention level when the participant is categorized in the second category, wherein the first intervention level and the second intervention level are different.

In one example, when the behavior is an unhealthy behavior, determining a motivation level of the participant further includes presenting at least one motivation question to the participant on the electronic device inquiring about when the participant will begin changing the unhealthy behavior to determine the motivation level of the participant.

In one example, the motivation level is a high motivation level when the participant has a high level of motivation to begin changing the unhealthy behavior, and wherein the motivation level is a low motivation level when the participant has a low level of motivation to begin changing the unhealthy behavior. The step of categorizing further includes categorizing the participant in the first category when the participant has a high motivation level and categorizing the participant in a second category different than the first category when the participant has a low motivation level.

In one example, the step of communicating further includes intervening with the participant at a first intervention level when the participant is categorized in the first category, and intervening with the participant at a second intervention level when the participant is categorized in the second category. The first intervention level and the second intervention level are different.

In on example, the step of assessing activities and communicating with the participant occur over a same network and via a same electronic device.

In one example, the step of assessing activities and communicating with the participant occur over different networks.

In one example, a method of altering a behavior of a participant associated with a health care system is provided. The method includes communicating first data associated with a first question over a network to an electronic device, wherein the first question pertains to a health activity of the participant, displaying the first question on a display of the electronic device, activating an input device on the electronic device by the participant to answer the first question, communicating second data associated with the answer to the first question over the network, determining a behavior of the participant based on at least the answer to the first question, wherein the behavior is one of a plurality of behaviors, communicating third data associated with a second question over the network to the electronic device, wherein the second question pertains to a participant's motivation to change the behavior, displaying the second question on the display of the electronic device, activating the input device on the electronic device by the participant to answer the second question, communicating fourth data associated with the answer to the second question over the network, determining a motivation level of the participant based on at least the answer to the second question, wherein the motivation level is one of a plurality of motivation levels, categorizing the participant into one of a plurality of categories based on the behavior and the motivation level of the participant, and communicating with the participant, over the network via the electronic device, based on the one of the plurality of categories in which the participant is categorized.

In one example, the first question is one of a plurality of first questions and the step of determining a behavior further includes determining a behavior of the participant based on answers to the first plurality of questions. The second question is one of a second plurality of questions and the step of determining a motivation level further includes determining a motivation level of the participant based on answers to the second plurality of questions.

### BRIEF DESCRIPTION OF THE DRAWINGS

The disclosure can be better understood with reference to the following drawings and description. The components in the figures are not necessarily to scale, emphasis instead being placed upon illustrating principles of the disclosure.

FIG. 1A depicts a block schematic diagram of an exemplary computing system of the present disclosure, the system is configured to perform at least a portion of the functionalities and methods of the present disclosure.

FIG. 1B depicts exemplary devices, an exemplary network and interaction between the devices and the network associated with the systems and methods of the present disclosure.

FIG. 2 depicts a block schematic diagram of an exemplary system of the present disclosure, the system is configured to perform at least a portion of the functionality and methods of the present disclosure.

FIG. 3 is a flow chart representing one example of a flow of the present disclosure, according to this example the flow may represent a staging, categorizing or segmenting process following a health assessment for risks.

FIG. 4 is an exemplary table associated with the present disclosure.

FIG. 5 is a flow chart representing one example of a flow of the present disclosure, this example represents exemplary interventions after staging, categorizing or segmenting, in accordance with one aspect of the present disclosure.

FIG. 6 is a flow chart representing one example of a flow of the present disclosure.

FIG. 7 depicts a block schematic diagram of an exemplary flow of the present disclosure.

### DETAILED DESCRIPTION

The present disclosure provides systems and methods for addressing behaviors of individuals that may result in negative or harmful health issues for the individuals. Additionally, the present disclosure determines an individual's motivation and readiness to address certain behaviors, primarily behaviors that may result in negative or harmful health issues. Such systems and methods may obtain data from the individuals, and utilize this data to assign each individual into a category or segment. Intervention with the individuals occurs based on the category or segment to which the individuals are assigned. This intervention is intended to alter the individual's behavior

In the description that follows, the subject matter of the application will be described with reference to acts and symbolic representations of operations that are performed by one or more computers, unless indicated otherwise. As such, it will be understood that such acts and operations, which are at times referred to as being computer-executed, include the manipulation, by the processing unit of the computer, of electrical signals representing data in a structured form. This manipulation transforms the data or maintains it at locations in the memory system of the computer which reconfigures or otherwise alters the operation of the computer in a manner well understood by those skilled in the art. The data structures, where data is maintained, are physical locations of the memory that have particular properties defined by the format of the data. However, although the subject matter of the application is being described in the foregoing context, it is not meant to be limiting as those skilled in the art will appreciate that some of the acts and operations described hereinafter can also be implemented in hardware, software, and/or firmware and/or some combination thereof.

With reference to FIG. 1A, depicted is an exemplary computing system for implementing aspects of the present disclosure. FIG. 1A includes a computer 100, which could be any one of or any combination of a mobile device 200, a personal computer, a remote server 240, an alike device, or other device. Computer 100 may be a portable device, wherein at least some or all of its components are formed together in a single device which can be carried around by a person. Alternatively, the computer 100 may be too large for one person to carry and the computer 100 may remain stationary during use.

The computer 100 includes a processor 110, memory 120 and one or more drives 130. The drives 130 and their associated computer readable memory medium provide storage of computer readable instructions, data structures, program modules and other data for the computer 100. Drives 130 can include an operating system 140, application programs 150, program modules 160, and program data 180. Computer 100 further includes input devices 190 through which data may enter the computer 100, either automatically or by a user who enters commands and data. Input devices 190 can include an electronic digitizer, a flatbed scanner, a barcode reader, a microphone, a camera, a video camera, a keyboard and a pointing device, commonly referred to as a mouse, a trackball or a touch pad, a pinpad, any USB device, any Bluetooth enabled device, an RFID or NFC device, a debit card reader, etc. Other input devices may include a joystick, game pad, satellite dish, scanner, and the like. In one or more examples, input devices 190 may direct display or instantiation of applications running on processor 110.

These and other input devices 190 can be connected to processor 110 through a user input interface that is coupled to a system bus 192, but may be connected by other interface and bus structures, such as a parallel port, game port or a universal serial bus (USB). Computers such as computer 100 may also include other peripheral output devices such as speakers, printers, and/or display devices, which may be connected through an output peripheral interface 194 and the like.

Computer 100 also includes a radio 198 or other type of communications device for wirelessly transmitting and receiving data for the computer 100 with the aid of an antenna. Radio 198 may wirelessly transmit and receive data using WiMAX™, 802.11a/b/g/n, Bluetooth™, 2G, 2.5G, 3G, 4G, or other wireless standards.

Computer 100 may operate in a networked environment using logical connections to one or more remote computers, such as a remote server 240. The remote server 240 may be a personal computer, a server, a router, a network PC, a peer device or other common network node, and may include many if not all of the elements described above relative to computer 100. Networking environments are commonplace in offices, enterprise-wide computer networks, intranets and the Internet. For example, computer 100 may comprise the source machine from which data is being migrated, and the remote computer may comprise the destination machine. Note, however, that source and destination machines need not be connected by a network or any other means, but instead, data may be migrated via any media capable of being written by the source platform and read by the destination platform or platforms. When used in a LAN or WLAN networking environment, computer 100 is connected to the LAN through a network interface 196 or an adapter. When used in a WAN networking environment, computer 100 typically includes a modem or other means for establishing communications over the WAN, such as radio 198, to environments such as the Internet. It will be appreciated that other means of establishing a communications link between computer 100 and other computers may be used.

With reference to FIG. 1B, illustrated is an exemplary representation of multiple computers of the system interacting with each other in an exemplary manner. In the illustrated example, one computer is a mobile device 200 and the other computer is a remote server 240. The system is cable of including other quantities and types of computers and interacting in other manners. In the illustrated example, mobile device 200 includes any portable electronic device having a processor 201 for executing applications and a display 206 for displaying information connected with the processor 201, and includes such devices as a personal desktop assistant (PDA), a portable computer, a mobile telephone, a smartphone, a netbook, a mobile vehicular computer, and a tablet computer. Display 206 can use any of a variety of types of display technologies, such as a liquid crystal display (LCD), a cathode-ray tube type display, an electronic ink display, a light emitting diode (LED) type display such as an OLED display, and a plasma display. The mobile device 200 also includes a communications device 208. The communications device 208 is connected with the processor 201 and capable of sending and receiving information between one or more other computers connected with the mobile device 200. Communications device 208 is capable of wirelessly transmitting signals to another computer, such as remote server 240, using a radio transmitter and a radio receiver connected with an antenna.

Communications device 208 communicates with another computer 100, such as remote server 240, via a network 226 using a network interface 209. Network interface 209 is connected with processor 201 and communications device 208, and may be disposed within remote device 200.

Network 226 may include any type of network that is capable of sending and receiving communication signals, including signals for multimedia content, images, data and streaming video. Network 226 may include a data network, such as the Internet, an intranet, a local area network (LAN), a wide area network (WAN), a cable network, and other like systems that are capable of transmitting information, such as digital data, and the like. Network 226 may also include a telecommunications network, such as a local telephone network, long distance telephone network, cellular telephone network, satellite communications network, cable television network and other like communications systems that interact with computer systems to enable transmission of information between mobile device 200 and another computer such as remote server 240. Network 226 may be comprised of more than one network and may include a plurality of different types of networks. Thus, network 226 may include a plurality of data networks, a plurality of telecommunications networks, cable systems, satellite systems and/or a combination of data and telecommunications networks and other like communication systems.

Network 226 is connected with both mobile device 200 and remote server 240 and allows for information to be transmitted and shared between mobile device 200 and remote server 240. Remote server 240 includes any type of computer which can receive, store, process, and transmit information to another computer and includes devices such as a server based computer system capable of interacting with one or more other computer systems.

In one example, mobile device 200 includes location information processing means which allows the mobile device 200 to determine its location. Location information processing means includes devices such a Global Positioning System (GPS) based device, and methods such as using radio triangulation to determine the location of the mobile device 200. In one example, the mobile device 200 includes input means 210 for entering information from a user into the mobile device 200. Input means includes any device which can assist a user to enter information, such as a keyboard, a mouse, a touchpad, a touchscreen, a joystick, a button, a dial, and the like. For example, the mobile device 200 may display a question to an individual pertaining to the individual activity as it relates to health. The individual may use the input means 210 to input an answer to the question. Data associated with the individual's answer may be transmitted from the mobile device 200, over the network 226, and to the remote server 240 where further steps associated with the systems and methods of the present disclosure may be performed (e.g., risk assessment, behavior categorization, etc.).

With reference to FIG. 2, an example of a system 300 of the present disclosure is illustrated. In one example, the system 300 may be part of the system illustrated in FIGS. 1A and 1B and may cooperate therewith to perform some or all of the steps and/or functions of the processes and methods of the present disclosure. In this example, the system 300 may be considered to include all or some of the components of the system illustrated in FIGS. 1A and 1B to carry out the steps and functionality of the present disclosure. In another example, the system 300 may not be part of the system illustrated in FIGS. 1A and 1B.

In the illustrated example, the system 300 is configured to assist numerous clients with addressing behaviors of individuals or employees associated with the clients that may result in negative health issues for the individuals. The system 300 includes a system administrator 302 configured to facilitate the clients' interaction with the system 300. The system administrator 302 has many responsibilities, tasks and functions within the system 300. For example, the system administrator 302 is capable of setting-up, managing and assisting various clients with interaction within the system 300. The system 300 may include one or more of the computers 100 illustrated in FIG. 1A and one or more sets of the devices illustrated in FIG. 1B.

With continued reference to FIG. 2, in this example, the system administrator 302 interacts with a system administrator management system 304 that includes, but is not limited to, a system administrator client management system (CMS) site 306 and a CMS database 308. The system administrator 302 is capable of creating, configuring, managing, modifying or otherwise interacting with client instances or platforms 310 using the CMS site 306 and the CMS database 308. The CMS database 308 stores information and/or data for use by the system 300 and such information and/or data may be retrieved and/or stored as necessary. As illustrated, the system administrator 302 can create and manage a plurality of clients. In fact, the system administrator 302 is configured to create and manage any number of clients. The client instances or platforms 310 may all be unique to accommodate the individual needs of each client. Alternatively, the client instances or platforms 310 may have some similarities where various clients have similar needs.

With further reference to FIG. 2, in this example, each client platform 310 includes a platform site 312 and a platform database 314. The platform site 312 may be accessed by participants or individuals 316 such as, for example, employees of the respective client, and accessed by client administrators 318 such as, for example, a Human Resources director or other assigned individual with sufficient clearance associated with the respective client. Participants 316 may access the site 312 to provide requested information about themselves and the platform site 312 may communicate information to the participant 316 in accordance with the present disclosure. The client administrator 318 may interact with the platform site 312 as necessary to provide information and to receive information from the system 300. Interaction such as, for example, sending and receiving information or data, with the participant 316 and client administrator 318 may occur over one or more networks 226 using one or more computers similar to the manner illustrated and described with respect to FIGS. 1A and 1B, or in other manners. The platform database 314 stores information and/or data for use by the system 300 and such information and/or data may be retrieved and/or stored as necessary.

In the illustrated example, the system 300 includes a system bus 320 for facilitating communication and/or transfer of data between various elements of the system 300. Alternatively, the system 300 may include other interfaces and bus structures. The system 300 may also include a data warehouse or data center 322. The data warehouse 322 includes, but is not limited to, a plurality of web services 324, a plurality of databases 326 and an advisor or coach platform 328. In one example, one of the databases 326 may be an EDW containing data pertaining to MPI, homegrown logic, participant eligibility, participant claims, claims WCF services, etc. For example, participant eligibility may contain data of a list of employees or participants who are eligible to access the respective client platform site 312. In one example, a second database may be a Siebel. The advisors platform 328 may provide advisors or coaches with information about the participants 316 so that the advisors can interpret the data and take appropriate action (e.g., intervention) (described in more detail below). Advisors may also provide data and/or information into the system 300 via the advisors platform 328. For example, the advisors may communicate with participants 316 over the system 300 via the advisors platform 328 (e.g., intervention). In one example, a plurality of advisors may interact with the advisors platform 328 on the system 300. For example, the advisors may include lifestyle coaches, health advisors, nurses, doctors, advance practice coaches, or any other appropriate individuals.

Furthermore, for example, the system 300 may be capable of transferring files 330 to third-party vendors 332 with single sign-on 334 such as, for example, third party applications 336.

It should be understood that the exemplary systems and associated functionality illustrated and described herein are provided for exemplary purposes and are not intended to be limiting upon the present disclosure. Rather, variations of the systems and associated functionality are possible and all of which are intended to be within the spirit and scope of the present disclosure.

At least some of the portions of the following description and associated figures may pertain to only a single participant, individual or person. However, it should be understood that the systems and methods of the present disclosure may be performed on any number of participants, individuals or people, and that the description and associated figures relating to a single individual, participant or person is presented to simplify the discussion in order to convey aspects of the present disclosure.

Referring now to FIG. 3, a schematic of one example of a flow of the system of the present disclosure is illustrated. FIG. 3 represents at least a portion of a staging, categorizing or segmenting process of the present disclosure. As shown in this figure, a health assessment for risk is conducted on an individual at 401. The system of the present disclosure is capable of identifying a plurality of types of health risks for an individual when conducting the health assessment 401. In the illustrated example, the system identifies three types of health risks such as, for example, unhealthy behaviors, absent behaviors, and biometric risks. It should be understood that the system is capable of identifying any number and any type of health risks and be within the intended spirit and scope of the present disclosure.

In the course of the health assessment at 401, questions are asked of the participant on the respective platform site (e.g., a web platform) that survey health risks for the participant.

The health assessment 401 may be conducted, in some examples of the present disclosure, on multiple platforms such as, for example, mobile platforms, internet platforms, etc.

The health assessment 401 may determine, among other things, a presence or absence of a set of health behaviors associated with development of chronic disease. In one example, the health behaviors may be of two types. Behaviors that are unhealthy and present in the participant's lifestyle (e.g., smoking), which are referred to as unhealthy behaviors, and behaviors that are missing from the participant's lifestyle that, as a result of their absence, are associated with increased risk of developing a chronic disease (e.g., lack of aerobic physical activity), which are referred to as absent behaviors.

After the system identifies various behaviors of the participant with the health assessment at 401, the system assesses a motivational level of the participant to identify potential areas where a behavior change may be made (e.g., a motivational interest survey). Assessment of the motivation level of participants may be included as part of the health assessment at 401 or may be performed separately and subsequently from the health assessment, for example, at steps 410 and 412.

Individuals or participants categorized as having unhealthy behaviors are analyzed at 410. Such participants will be presented with questions to reveal, among other things, an indication of the participant's current state of motivation to change. Individuals or participants categorized as having absent behaviors are analyzed at 412 where participants are subjected to questions that also determine, among other things, the participants' motivation to change. In one example, the questions may pertain to behavioral sampling and, in some situations, the participant's personal interests are determined.

In one example, unhealthy behaviors may have a unique set of motivation assessment questions that differ from the set of motivation assessment questions for absent behaviors. Thus, depending on the behavioral categorization of the participant, the participant may receive a designed set of questions based on the identified behavior of that particular participant.

In one example, with respect to absent behaviors, the participant may be presented with a list of all absent behaviors identified in the health assessment 401 and may be requested to select an absent behavior activity that the participant may be most willing to work on. After completion of the assessment of the motivation level of the participant (e.g., motivational interest survey), results of the motivation assessment will assist in determining an interest level of the participant in a selected activity. After the interest or motivational level is determined, an activity may be suggested to the participant to alter the participant's behavior based on the motivational assessment and the determined interest level. The activity may be suggested in a variety of manners including, but not limited to, an electronic communication over the system by an advisor or coach, a telephone call from an advisor or coach, a paper mailing, or any other manner of communication.

The information collected from the participant may be used to determine interventional approach(es) that may likely alter a participant's behavior to result in a more positive health situation. For example, it is desirable to permanently alter a participant's behavior to include less unhealthy behaviors, less absent behaviors and/or more healthy behaviors.

In one example, underlying the interventional approach of the present disclosure is a finding that certain psychological approaches work better for unhealthy behaviors and other psychological approaches work better for absent behaviors. In some examples of the present disclosure, specific participant intervention may be based on the type of behavior that is in need of being changed and a unique motivational assessment for the type of behavior. The systems and methods of the present disclosure segment or categorize participants into various segments or categories, based on type of behaviors and level of motivation, in order to provide specialized and appropriate intervention to the participants in each segment or category in order to alter the participants' behaviors.

With continued reference to FIG. 3, the health assessment 401 is utilized to determine types of participant behaviors 410, 412, and further questions occur at blocks 410, 412 to determine participant motivation. Upon identification of participant behaviors and motivation, participants are segmented further based on their behaviors and motivation.

FIG. 3 illustrates one example of further categorization of the participants. If the system determines that participants have unhealthy behaviors at 401 and has high motivation at 410, the participants are segmented into a first category or segment 420 pertaining to unhealthy behaviors and high motivation. That is, if participants have unhealthy behaviors in their lifestyle, but are highly motivated to change the unhealthy behaviors, the participants are categorized in the first category 420. For illustrative purposes, the first category may be referred to as Behavior Segment 1 (BS1). At 422, a second category or segment is represented and is associated with participants that are identified as being positive for unhealthy behaviors (via health assessment 401) and have low motivation to change (via questioning at 410). That is, if participants have unhealthy behaviors in their lifestyle and are not motivated or have low motivation to change the unhealthy behaviors, the participants are categorized in the second category 422. For illustrative purposes, the second category may be referred to as Behavior Segment 2 (BS2). At 424, a third category or segment is represented and is associated with participants that are identified as being positive for unhealthy behaviors (via health assessment 401) and have other life factors that provide significant negative impacts (via questioning at 410). For illustrative purposes, the third category 424 may be referred to as Behavior Segment 3 (BS3).

If it is determined that the participants have absent behaviors at 401 and the participants' motivational level is low at 412, then the participants may be segmented into a fourth category or segment at 428. In the fourth category, healthy behaviors are absent from the participants' lifestyle and the participants have low motivation to change these behaviors. For illustrative purposes, the fourth category 428 may be referred to as Behavior Segment 4 (BS4).

If the health assessment at 401 determines that participants have all healthy behaviors or have no unhealthy behaviors, the participants are categorized into a fifth category or segment at 430. No intervention may be required when the participants are categorized in this fifth category 430.

In one example of the present disclosure, the assessments performed at 410 and 412 may utilize TransTheroretical Model (TTM) Staging. TTM may utilize a variety of questions to determine an appropriate category for the participants. One example of a question may include asking the participants how likely they will be ready to change a behavior or their lifestyle in longer than 6 months, within 6 months, within 30 days, or are ready to change now. This is only one example of many possible questions and is not intended to limit the present disclosure. Many other questions are possible and are intended to be within the spirit and scope of the present disclosure.

Referring to the determinations and categorizations made in FIG. 3, further reference is made to FIG. 4 where the determinations and categorizations are summarized. As a result of the behavior identification and the motivational level determination, a psychological state of the participants may be assigned or allocated. For example, in FIG. 4, psychological states “good” and “poor” are assigned to various categories. It should be understood that the quantity and types of psychological states can vary from application to application, from client to client, or for a variety of other reasons, some of which may be objective or subjective. Thus, the psychological states described and illustrated herein are only examples and the present disclosure is capable of using any quantity and any type of psychological states and be within the intended spirit and scope of the present disclosure. In one example, the psychological state characterization may be utilized to allocate a particular type of intervention to the participants.

FIG. 5 illustrates an exemplary flow of the present disclosure including examples of interventions with participants. Interventions that are offered to the participants depend on the categorization of the participant based on the type of behavior and the level of motivation. In one example, interventions may also be determined in response to the type of behavior that the participants are most likely to change based on information provided by the participants (e.g., absent behavior, unhealthy behavior, etc.).

In one example, with respect to absent behaviors, participants may be offered an opportunity to initially perform a simple, easy to do task, for either a single time or a very short period of time. The tasks are tracked in an electronic record and that record is used to create a process to generate reinforcement of the success of achieving that goal and offers an opportunity to perform the same task again, but lasting a longer period or span of time. This approach of offering more difficult and lengthy goals continues until the participants form a habit.

With respect to unhealthy behaviors, a different approach may be used. In one example, participants with high motivation to change their unhealthy behaviors may be offered skills and psychological processes to take action immediately to reduce or eliminate the unhealthy behaviors. If the current motivational level is not high enough to reduce or eliminate the unhealthy behavior, the participants may receive tailored messaging that assist in creating higher motivational levels to change the unhealthy behavior. If the participants also have absent behaviors along with the unhealthy behaviors, there is concurrent offering of easy to do simple activities in the same fashion as those with absent behaviors. The motivational level of the unhealthy behaviors is assessed through a survey periodically and, when the motivational level is high, interventions are offered for the unhealthy behavior.

With continued reference to FIG. 5, one illustrated example of interventions will be described. This illustrated example is not intended to be limiting. Rather, the systems and methods of the present disclosure are capable of many different types and quantities of interventions and all of such possibilities are intended to be within the spirit and scope of the present disclosure. Participants categorized in the first category 420, which includes positive for unhealthy behaviors and high motivation, are subjected to a first intervention 500. In one example, the first intervention 500 may be referred to as Intervention Type 1 and may include TTM. In this example, Type 1 interventions based on the Transtheoretical Model for behavior change support participants going through the process of change as defined by the TTM. Also included in this intellectual framework are techniques that help participants who move through the stages-of-change.

Participants categorized in the second category 422, which includes positive for unhealthy behaviors and low motivation, are subjected to a second intervention 502. In one example, the second intervention 502 may be referred to as Intervention Type 2 and may include, among other things, communication strategy from type 1. In this example, Intervention Type 2 relies on identifying a behavior or behaviors to add to the participant's repertoire, using the least motivation necessary. Behavioral shaping builds healthy habits that limit the risk of chronic disease.

Participants categorized in the fourth category 428, which includes participants with absent behaviors and low motivation, are subjected to a third intervention 504. In one example, the third intervention 504 may be referred to as Intervention Type 3 and may include behavior shaping with small steps.

Participants categorized in the fifth category 430, which includes participants with all healthy behaviors, do not require intervention 506. In some examples, the participants in the fifth category 430 may be contacted to act as healthy role models for participants in other categories.

The request for and collection of data from participants, along with interventions with participants based on the categorization, may occur in a variety of manners including, but not limited to, telephonic, face-to-face, electric communications over a network such as, for example, email, web pages, texts, social media, etc., or other modes to interact with participants in the most effective means to improve health status.

Referring now to FIG. 6, a flow chart of one example of a process associated with the present disclosure is illustrated. This is only one example of a process associated with the systems and methods of the present disclosure. The systems of the present disclosure are capable of performing many other processes and having much more functionality, and all of such possibilities are intended to be within the spirit and scope of the present disclosure. Moreover, the following steps and/or functions described and illustrated with respect to FIG. 6 are only examples of steps and/or functions, and the processes of the present disclosure are capable of including more or less steps and/or functions, altogether different steps and/or functions, and the steps and/or functions may be performed in a variety of different orders. Thus, the exemplary process illustrated in FIG. 6 is not intended to be limiting in any manner.

As shown in FIG. 6, a participant logs into the system 601 and registers 602 using, for example, an electronic device over a network. The participant selects the health assessment in a program bar of the associated client platform site at 604 and/or the health assessment in a “to-do” list at 606. The health assessment is performed at 610. The health assessment may be performed by providing questions to and receiving information or data from the participant in one of a variety of manners including, but not limited to, over one or more networks, via mail, over the telephone, etc. In examples using one or more networks, the participant may answer the questions using an electronic device including, but not limited to, a personal computer, a telephone, a cellular telephone, a smartphone, a tablet computer, etc. Information and/or data may be sent and received by the electronic device over one or more networks such as, for example, the Internet, a cellular network, or any other type of network.

After the necessary information or data has been received from the participant, which, in one example, may also correspond to a completion of the health assessment, the system determines if the participant has unhealthy behaviors 660 or absent behaviors 620.

If a participant has absent behaviors 620, the participant's absent behaviors are compared to a compiled list of healthy behaviors 622. Then, a list of healthy behaviors is displayed to the participant 624 (via, e.g., an electronic device) and the participant selects a behavior that the participant is willing to work on 326. Based on the information previously collected from the participant, the participant is segmented into an appropriate category 630. Based on the category with which the participant is segmented, the type of intervention that will most likely be beneficial to the participant is selected 632. The participant then has several options to continue. In one example, the participant may select between two options: Coaching or self-directed 640. If the participant selects coaching, then the system informs a coach of which intervention to use for the participant based on the type of behavior and the motivation level 642. If the participant selects self-directed, the system offers a self-directed program to the participant based on the participant's type of behavior and motivation 644. Intervention types 1 and 2, and any other type of intervention (not shown), are also made available to the participant 646 and 648, respectively.

Referring back to block 610, if the health assessment identifies that the participant has unhealthy behaviors at 660, one or more question(s) is(are) displayed to the participant (via, e.g., an electronic device) 662 as to when the change in the behavior is desired. Then, data previously collected from the participant may be used to calculate a priority status of change accommodation 670. The system then populates a “to-do” list at block 672 and/or decides the next appropriate web page to display (e.g., on an electronic device) to the participant 674 based on the calculation at 670.

The process then may proceed to registration of the participant for a self-directed program at 680, production of a health summary of the participant at 682, registration of the participant for coaching at 684, or other options.

With reference to FIG. 7, a flow chart of another example of a process associated with the present disclosure is illustrated. This is only one example of a process associated with the present disclosure and, as indicated above, other processes, steps, functions, orders of steps and/or functions are possible, and all of which are intended to be within the spirit and scope of the present disclosure.

With continued reference to FIG. 7, information or data associated with a participant may be input into the system in one or more manners 702. Information or data associated with a participant may originate from a wide variety of sources and all of such are intended to be within the intended spirit and scope of the present disclosure. Some examples of data or information sources include, but are not limited to, medical and/or pharmacy claims of the participant, biometric data of the participant, information obtained directly from the participant (e.g., the health assessment), etc. The system includes an analyzing engine configured to receive the data and analyze the data 704. The analyzing engine may be any type of device or combination of devices configured to perform these functions including, but not limited to, a computer, a computing device, a processor, memory, hardware, software, a combination of hardware and software, a predictive modeling engine, or the like. The engine is configured to perform a wide variety of types of analysis with the received data. For example, the analyzing engine may determine: past participant utilization; predicted or future participant utilization; past participant costs; predicted or future participant costs; re-admission rates for the participant; if the participant has a chronic disease; if the participant has comorbidities; participant's compliance with care standards; participant's adherence to pharmacy standards; participant's daily living activities; if multiple providers exist; participant's emergency room visits; etc.

As a result of the analysis performed by the engine, the system segments, categorizes or places the participants into one of a plurality of categories or segments 706. As indicated above, the systems and methods of the present disclosure are capable of including any quantity and any type of categories. Thus, the present illustrated example is not intended to be limiting. In the illustrate example, the system includes eight categories or segments ranging from little to no participant concern to very high participant concern. These exemplary categories include: None—a participant has no health concerns; Low—a participant may have some health concerns, but they are low; Moderate—a participant may have some health concerns and they are moderate; High—a participant may have a higher amount of health concerns (e.g., the participant is a smoker); Chronic #1—a participant has a chronic health condition, but the participant is managing the chronic health condition well; Chronic #2—a participant has a chronic health condition and is not managing the chronic health condition well; High Cost—a participant has severe health conditions and has high costs associated with treating the severe health conditions; and Emergent High Cost—a participant has more severe health conditions and higher costs than the High Cost category.

In the illustrated example, interventions are determined and provided after segmenting participants into categories 708. The level of intervention with a participant may depend on the category in which the participant is segmented and the severity of the category 708. Intervention may range from a higher level for more severe categories to non-existent for no concern categories. Any number of types or levels of intervention may be performed in the systems and methods of the present disclosure. For example, interventions may include, but are not limited to: Health advising; personalized messaging—preventive care gaps; lifestyle management; personalized messaging—chronic care gaps; condition management; and identify and refer to case management. Additionally, these exemplary interventions may be provided to participants in any number of categories. That is, each intervention may be applied to participants in multiple categories. Similarly, participants in particular categories may have multiple options for intervention. As indicated above, interventions may occur in a variety of manners including, but not limited to, electronic manners (e.g., electronic devices communicating over one or more networks), telephone, mail, etc.

In the illustrated example, health advising intervention may be provided to any participant in any category. Health advising may include, but is not limited to, general and basic advice about health. Advisors or coaches may be involved with health advising and may communicate with the participants in these categories in any of the manners described herein.

In the illustrated example, personalized messaging intervention pertaining to preventive care gaps may be provided to participants in all categories and may include, but is not limited to, informing participants of possible, foreseeable, or actual gaps in performance of preventive care activities. Preventive care activities are those activities recommended by the healthcare industry that be performed by participants to assist with preventing poor health conditions in the future. Intervention may occur with those participants that have not performed all of the recommend preventive care activities or remind participants of upcoming activities. Advisors or coaches may be involved with this personalized messaging and may communicate with the participants in these categories in any of the manners described herein.

In the illustrated example, personalized messaging intervention pertaining to chronic care gaps may be provided to participants in the Chronic #1, Chronic #2, High Cost and Emergent High Cost categories and may include, but is not limited to, informing participants of possible, foreseeable, or actual gaps in performance of chronic care activities. Chronic care activities are those activities recommended by the healthcare industry that be performed by participants with chronic health conditions to assist with management of their chronic health conditions in the future. Intervention may occur with those participants that have not performed all of the recommend chronic care activities or remind participants of upcoming activities. Advisors or coaches may be involved with this personalized messaging and may communicate with the participants in these categories in any of the manners described herein.

In the illustrated example, lifestyle management intervention may be provided to participants in the Low, Moderate and High categories and may include advice from a health coach on how to manage or improve the participants' lifestyle to better manage any existing poor health conditions or prevent or inhibit future poor health conditions. Advisors or coaches may be involved with lifestyle management and may communicate with the participants in these categories in any of the manners described herein.

In the illustrated example, condition management intervention may be provided to participants in the Chronic #1 and Chronic #2 categories and may include more aggressive advice or intervention with the participants to change, alter or manage participants' conditions. For participants in the Chronic #1 category, an advanced practice or health coach may intervene with the participants to assist participants with management of their chronic health condition. For participants in the Chronic #2 category, a nurse or doctor coach may intervene with the participants to assist participants with better management of their chronic health conditions since the participants are not adequately managing their conditions. Advisors or coaches may be involved with condition management and may communicate with the participants in these categories in any of the manners described herein. In one example, nurses, doctors or other trained healthcare professionals may be necessary to intervene with the participants at a higher level in order to improve the management of the participants' chronic health condition.

In the illustrated example, identify and refer to case management internvention may be provided to participants in the categories with the highest health risk. In the illustrated example, identify and refer to case management internvention is provided to participants in the High Cost category and the Emergent High Cost category and may include the most aggressive intervention of all. Participants in these categories may be identified and referred to case management where one or more individuals analyze the participants' situation in greater detail. Advisors or coaches may be involved with this process and may communicate with the participants in these categories in any of the manners described herein. The participants may be contacted and intervened with by advisors or coaches at a greater level to attempt to change the behaviors and/or the participants' motivation. Moreover, this intervention may include warm transfers, reporting, case conferences, etc.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the systems, methods, processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the systems, devices, methods and/or processes via the use of block diagrams, schematics, flowcharts, and/or examples. Insofar as such block diagrams, schematics, flowcharts, and/or examples contain one or more functions and/or operations, it will be understood by those within the art that each function and/or operation within such block diagrams, schematics, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a computer readable memory medium such as a magnetic medium like a floppy disk, a hard disk drive, and magnetic tape; an optical medium like a Compact Disc (CD), a Digital Video Disk (DVD), and a Blu-ray Disc; computer memory like random access memory (RAM), flash memory, and read only memory (ROM); and a transmission type medium such as a digital and/or an analog communication medium like a fiber optic cable, a waveguide, a wired communications link, and a wireless communication link.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include, but are not limited to, physically mateable and/or physically interacting components, and/or wirelessly interactable and/or wirelessly interacting components, and/or logically interacting and/or logically interactable components.

Those skilled in the art will recognize that it is common within the art to implement devices and/or processes and/or systems in the fashion(s) set forth herein, and thereafter use engineering and/or business practices to integrate such implemented devices and/or processes and/or systems into more comprehensive devices and/or processes and/or systems. That is, at least a portion of the devices and/or processes and/or systems described herein can be integrated into comprehensive devices and/or processes and/or systems via a reasonable amount of experimentation.

Although the present disclosure has been described in terms of specific embodiments and applications, persons skilled in the art can, in light of this teaching, generate additional embodiments without exceeding the scope or departing from the spirit of the present disclosure described herein. Accordingly, it is to be understood that the drawing and description in this disclosure are proffered to facilitate comprehension of the present disclosure, and should not be construed to limit the scope thereof.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the present disclosure is defined by the appended claims. Accordingly, the present disclosure is not to be restricted except in light of the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A method of altering a behavior of a participant associated with a health care system, the method comprising:
assessing activities of the participant over a network via at least one electronic device;
determining a behavior of the participant based on the activities of the participant;
determining a motivation level of the participant, wherein the motivation level is associated with an extent to which the participant is willing to change the behavior;
categorizing the participant into a first category of a plurality of categories based on the behavior and the motivation level of the participant; and
communicating with the participant based on the category in which the participant is categorized over a network via at least one electronic device.

2. The method of claim 1, wherein assessing activities further includes:
presenting a plurality of questions to the participant over the network to the at least one electronic device;
displaying the plurality of questions on the at least one electronic device for viewing by the participant; and
communicating data associated with the participant's answers to the plurality of questions over the network.

3. The method of claim 2, wherein the network is one of an Internet, an intranet, a cellular network, a local area network (LAN), a wide area network (WAN), and a cable network.

4. The method of claim 2, wherein the at least one electronic device is at least one of a personal computer, a portable computer, a tablet computer, a smartphone, a cellular phone, and a hardwired telephone.

5. The method of claim 1, wherein the behavior is one of an unhealthy behavior and an absent behavior.

6. The method of claim 5, wherein categorizing further includes categorizing the participant in the first category when the behavior is an unhealthy behavior and categorizing the participant in a second category different than the first category when the behavior is an absent behavior.

7. The method of claim 6, wherein communicating further includes:
intervening with the participant at a first intervention level when the participant is categorized in the first category; and
intervening with the participant at a second intervention level when the participant is categorized in the second category, wherein the first intervention level and the second intervention level are different.

8. The method of claim 1, wherein the behavior is one of an unhealthy behavior and an absent behavior, and wherein the motivation level is one of a high motivation level and a low motivation level.

9. The method of claim 8, wherein categorizing further includes:
categorizing the participant in the first category when the behavior is an unhealthy behavior and the motivation level is a high motivation level;
categorizing the participant in a second category of the plurality of categories when the behavior is an unhealthy behavior and the motivation level is a low motivation level;
categorizing the participant in a third category of the plurality of categories when the behavior is an absent behavior and the motivation level is a high motivation level; and
categorizing the participant in a fourth category of the plurality of categories when the behavior is an absent behavior and the motivation level is a low motivation level.

10. The method of claim 9, wherein communicating further includes:
intervening with the participant at a first intervention level when the participant is categorized in the first category;
intervening with the participant at a second intervention level when the participant is categorized in the second category;
intervening with the participant at a third intervention level when the participant is categorized in the third category; and
intervening with the participant at a fourth intervention level when the participant is categorized in the fourth category;
wherein the first intervention level, the second intervention level, the third intervention level and the fourth intervention level are different.

11. The method of claim 5, wherein, when the behavior is an absent behavior, the method further comprises:
comparing the absent behavior to a list of healthy behaviors stored in a database; and
identifying at least one healthy behavior absent from the activities of the participant.

12. The method of claim 11, wherein determining a motivation level of the participant further includes:
displaying the at least one healthy behavior on the electronic device for the participant to view; and
presenting at least one motivation question to the participant on the electronic device pertaining to the at least one healthy behavior displayed on the electronic device to determine the motivation level of the participant to begin performing the at least one healthy behavior.

13. The method of claim 12, wherein the motivation level is a high motivation level when the participant has a high level of motivation to begin performing the at least one healthy behavior, and wherein the motivation level is a low motivation level when the participant has a low level of motivation to begin performing the at least one healthy behavior, wherein categorizing further includes categorizing the participant in the first category when the participant has a high motivation level and categorizing the participant in a second category of the plurality of categories different than the first category when the participant has a low motivation level.

14. The method of claim 13, wherein communicating further includes:
intervening with the participant at a first intervention level when the participant is categorized in the first category; and
intervening with the participant at a second intervention level when the participant is categorized in the second category, wherein the first intervention level and the second intervention level are different.

15. The method of claim 5, wherein, when the behavior is an unhealthy behavior, determining a motivation level of the participant further includes:
presenting at least one motivation question to the participant on the electronic device inquiring about when the participant will begin changing the unhealthy behavior to determine the motivation level of the participant.

16. The method of claim 15, wherein the motivation level is a high motivation level when the participant has a high level of motivation to begin changing the unhealthy behavior, and wherein the motivation level is a low motivation level when the participant has a low level of motivation to begin changing the unhealthy behavior, wherein categorizing further includes categorizing the participant in the first category when the participant has a high motivation level and categorizing the participant in a second category different than the first category when the participant has a low motivation level.

17. The method of claim 16, wherein communicating further includes:
intervening with the participant at a first intervention level when the participant is categorized in the first category; and
intervening with the participant at a second intervention level when the participant is categorized in the second category, wherein the first intervention level and the second intervention level are different.

18. The method of claim 1, wherein assessing activities and communicating with the participant occur over a same network and via a same electronic device.

19. The method of claim 1, wherein assessing activities and communicating with the participant occur over different networks.

20. A method of altering a behavior of a participant associated with a health care system, the method comprising:
communicating first data associated with a first question over a network to an electronic device, wherein the first question pertains to a health activity of the participant;
displaying the first question on a display of the electronic device;
activating an input device on the electronic device by the participant to answer the first question;
communicating second data associated with the answer to the first question over the network;
determining a behavior of the participant based on at least the answer to the first question, wherein the behavior is one of a plurality of behaviors;
communicating third data associated with a second question over the network to the electronic device, wherein the second question pertains to a participant's motivation to change the behavior;
displaying the second question on the display of the electronic device;
activating the input device on the electronic device by the participant to answer the second question;
communicating fourth data associated with the answer to the second question over the network;
determining a motivation level of the participant based on at least the answer to the second question, wherein the motivation level is one of a plurality of motivation levels;
categorizing the participant into one of a plurality of categories based on the behavior and the motivation level of the participant; and
communicating with the participant, over the network via the electronic device, based on the one of the plurality of categories in which the participant is categorized.

21. The method of claim 20, wherein the first question is one of a plurality of first questions and determining a behavior further includes determining a behavior of the participant based on answers to the first plurality of questions, and wherein the second question is one of a second plurality of questions and determining a motivation level further includes determining a motivation level of the participant based on answers to the second plurality of questions.
